(19) United States
(12) Patent Application Publication
(10) Pub. No.: US 2012/0052400 A1
(43) Pub. Date: Mar. 1, 2012

(54) ELECTRODE STRUCTURE AND METHOD FOR MANUFACTURING THE ELECTRODE STRUCTURE, AND ENERGY STORAGE APPARATUS WITH THE ELECTRODE STRUCTURE

(75) Inventors: Hak Kwan KIM, Gyeonggi-do (KR); Bae Kyun KIM, Gyeonggi-do (KR); Dong Hyeok CHOI, Gyeonggi-do (KR); Hyun Chul JUNG, Gyeonggi-do (KR)

(73) Assignee: SAMSUNG ELECTRO-MECHANICS CO., LTD.

(21) Appl. No.: 13/222,517

(22) Filed: Aug. 31, 2011

(30) Foreign Application Priority Data
Aug. 31, 2010 (KR) 10-2010-0084819

(51) Int. Cl. H01M 10/056; H01G 9/042; H01M 4/60; H01M 4/139; H01M 4/62; H01M 4/583

(52) U.S. Cl. 429/339; 429/232; 429/231.7; 429/231.8; 429/213; 29/623.1; 29/623.5; 429/341; 429/207; 29/25.03; 361/502

(57) ABSTRACT

Disclosed herein is an electrode structure for an energy storage apparatus. The electrode structure according to an exemplary embodiment of the present invention includes a current collector; and an active material layer formed in the current collector, wherein the active material layer includes: an active material; and a conductive material having a relatively higher content than that of the active material as being away from the current collector.

### CROSS REFERENCE TO RELATED APPLICATION

This application claims the benefit of Korean Patent Application No. 10-2010-0084819, filed on Aug. 31, 2010, entitled “Electrode Structure And Method For Manufacturing The Electrode Structure, And Energy Storage Apparatus With The Electrode Structure”, which is hereby incorporated by reference in its entirety into this application.

### BACKGROUND OF THE INVENTION

1. Technical Field

The present invention relates to an electrode structure and a method for manufacturing the electrode structure, and an energy storage apparatus with the electrode structure, and more particularly, to an electrode structure implementing equivalent series resistance (ESR), high output, and high capacity and a method for manufacturing the electrode structure, and an energy storage apparatus with the electrode structure.

2. Description of the Related Art

Among next-generation energy storage apparatuses, an apparatus called an ultra capacitor or a super capacitor has been in the limelight as next-generation energy storage apparatus due to rapid charging/discharging rate, high stability, and environment-friendly characteristics. As representative super capacitors, a lithium ion capacitor (LIC), an electric double layer capacitor (EDLC), a pseudocapacitor, a hybrid capacitor, and the like, have been currently used.

Among those, the electric double layer capacitor (EDLC) uses a carbon material having high environment-friendly characteristics and high stability as an electrode material. Generally, the electrode structure of the electric double layer capacitor may be manufactured by applying active material compositions formed by mixing a conductive material, a binder, other various additives, or the like, with an active material made of a carbon material such as an activated carbon to a metal current collector.

The capacity characteristics of the electric double layer capacitor are changed by the structure and material characteristics of the electrode structure, or the like. In particular, the relative content of the active material and the conductive material has a large effect on the capacity characteristics of the electric double layer capacitor. For example, when the content of the conductive material is increased, the resistance of the electrode structure is reduced such that the content of the active material is relatively reduced, thereby reducing capacitance of a capacitor. On the other hand, when the content of the active material is increased, the capacitance is increased but the internal resistance of the electrode structure is also increased, such that the output density of the electrode structure is reduced.

Meanwhile, the resistance of the electrode structure is generally increased as being away from the current collector. Therefore, like the lithium ion capacitor (LIC), when the capacitance of the energy storage apparatus is increased as the thickness of the positive electrode is designed to be thicker, as the thickness of the electrode structure is thicker, a phenomenon that the electric conductivity is non-uniform in the thickness direction of the electrode structure occurs. In this case, when the energy storage apparatus is charged and discharged, the phenomenon that only the active material layer adjacent to the current collector is used and the active material layer of the area relatively away from the current collector is not used occurs. Therefore, when the thickness of the electrode structure is generally designed to be thick, only the active material layer adjacent to the current collector is used, such that the energy density is low and the active material layer is locally deteriorated, thereby deteriorating the charging and discharging cycle characteristics.

### SUMMARY OF THE INVENTION

An object of the present invention is to provide an electrode structure implementing low equivalent series resistance (ESR), high capacity, and high output and an energy storage apparatus with the electrode structure.

Another object of the present invention is to provide an electrode structure improving application of an active material layer and an energy storage apparatus with the electrode structure.

Another object of the present invention is to provide a method for manufacturing an electrode structure implementing low equivalent series resistance (ESR), high capacity, and high output.

Another object of the present invention is to provide a method for manufacturing an electrode structure improving application of an active material layer.

According to an exemplary embodiment of the present invention, there is provided an electrode structure, including: a current collector; and an active material layer formed in the current collector, wherein the active material layer includes: an active material; and a conductive material having a relatively higher content than that of the active material as being away from the current collector.

The active material may have a smaller occupying area as being away from the current collector.

The active material may include a carbon material having a smaller size as being away from the current collector.

The carbon material may include at least any one of activated carbon, graphite, carbon aerogel, polyacrylonitrile (PAN), carbon nano fiber (CNF), activating carbon nano fiber (ACNF), and vapor grown carbon fiber (VGCF).

The conductive material may include a conductive powder having a higher occupying area as being away from the current collector.

The conductive powder may include at least any one of carbon black, ketjen black, carbon nano tube, and graphene.

The conductive material may further include: a first conductive material uniformly distributed on the active material layer; and a second conductive material having a high content as being away from the current collector and having electric conductivity higher than that of the first conductive material.

The first conductive material may include at least any one of carbon black, ketjen black, carbon nano tube, and graphene, and the second conductive material may include the other one of carbon black, ketjen black, carbon nano tube, and graphene.

According to an exemplary embodiment of the present invention, there is provided a method for manufacturing an electrode structure, including: preparing a current collector; preparing a plurality of active material compositions having relatively different contents of conductive material as compared to the active material; and sequentially forming the active material composition having the high content of the conducive material from the active material composition having the relatively low content of the conductive material among the active material compositions on the current collector.

The preparing the active material compositions may include: preparing a first active material composition including the active material and the conductive material; and preparing a second active material composition having the relatively higher content of the conductive material than that of the first active material composition, and the sequentially forming the active material composition having the high content of the conducive material from the active material composition having the relatively low content of the conductive material may include: applying the first active material composition on the current collector; and applying the second active material composition on the first active material composition.

The preparing the active material compositions may include: preparing a first active material composition including the active material and the conductive material; and preparing a second active material composition having the size of the active material smaller than that of the first active material composition.

The active material may include at least any one of activated carbon, graphite, carbon aerogel, polyacrylonitrile (PAN), carbon nano fiber (CNF), activating carbon nano fiber (ACNF), and vapor grown carbon fiber (VGCF).

The conductive material may include a conductive powder having electric conductivity higher than the active material, and the conductive powder includes at least any one of carbon black, ketjen black, carbon nano tube, and graphene.

The conductive material may include a first conductive material and a second conductive material having electric conductivity than that of the first conductive material, the first conductive material uses at least any one of carbon black and ketjen black, and the second conductive material uses at least any one of carbon nano tube and graphene.

According to an exemplary embodiment of the present invention, there is provided an energy storage apparatus, including: an electrolyte solution; a separator disposed in the electrolyte solution; a negative electrode disposed at one side of the separator in the electrolyte solution; and a positive electrode disposed at the other side of the separator in the electrolyte solution, wherein the negative electrode and the positive electrode each includes: a current collector; and an active material layer formed in the current collector, wherein the active material layer includes: an active material; and a conductive material having a relatively higher content than that of the active material as being away from the current collector.

The active material may include a carbon material having a smaller size as being away from the current collector, and the carbon material includes at least any one of activated carbon, graphite, carbon aerogel, polyacrylonitrile (PAN), carbon nano fiber (CNF), activating carbon nano fiber (ACNF), and vapor grown carbon fiber (VGCF).

The conductive material may include a carbon material having a high content size as being away from the current collector, and the conductive powder includes at least any one of carbon black, ketjen black, carbon nano tube, and graphene.

The current collector of the negative electrode and the positive electrode may include an aluminum foil, the active material layer includes activated carbon, and the negative electrode and the positive electrode form an electrode structure of an electric double layer capacitor (EDLC).

The current collector of the negative electrode may include a copper foil, the active material layer of the negative electrode include graphite, the current electrode of the positive electrode includes an aluminum foil, the active material layer of the positive electrode includes activated carbon, and the negative electrode and the positive electrode forms an electrode structure of a lithium ion capacitor (LIC).

The electrolyte solution may include at least any one of tetraethyl ammonium tetrafluoroborate (TEABF4), tetraethylmethyl ammonium tetrafluoroborate (TEMABF4), ethylmethyl ammonium tetrafluoro (EMBF4), and diethylmethyl ammonium tetrafluoroborate (DEMEBF4) or the non-lithium-based electrolyte salt may include spirobipyrrolidinium tetrafluoroborate (SBPBF4).

The electrolyte solution may include an electrolyte salt including at least any one of LiPF6, LiBF4, LiSbF6, LiAsF5, LiClO4, LiN, CF3SO3, LiC, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

### BRIEF DESCRIPTION OF THE DRAWINGS

FIG. 1 is a diagram showing an electrode structure according to an exemplary embodiment of the present invention;

FIG. 2 is an enlarged view of area A shown in FIG. 1;

FIG. 3 is a flowchart showing a method for manufacturing an electrode structure according to an exemplary embodiment of the present invention;

FIGS. 4 and 5 are diagrams for explaining a process of manufacturing an electrode structure according to an exemplary embodiment of the present invention;

FIG. 6 is a diagram showing an energy storage apparatus according to an exemplary embodiment of the present invention; and

FIG. 7 is a diagram showing an energy storage apparatus according to another exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, an energy storage apparatus according to the present invention will be described in detail with reference to the accompanying drawings.

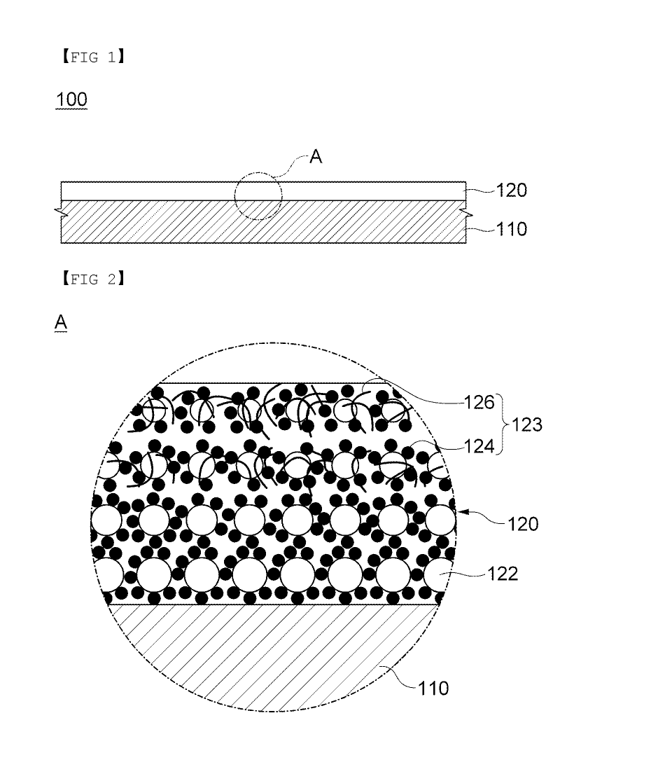

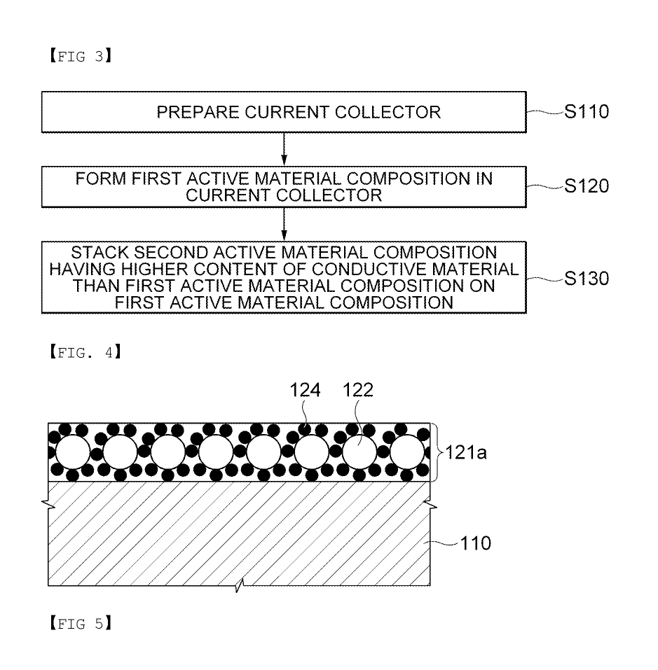

FIG. 1 is a diagram showing an electrode structure according to an exemplary embodiment of the present invention and FIG. 2 is an enlarged view of area A shown in FIG. 1.

Referring to FIGS. 1 and 2, an electrode structure 100 according to an exemplary embodiment of the present invention may be an electrode for a predetermined energy storage apparatus. As an example, the electrode structure 100 may be any one of a positive electrode and a negative electrode of the energy storage apparatus called an ultracapacitor or a supercapacitor. As another example, the electrode structure 100 may be configured to be used as any one of a positive electrode and a negative electrode of a secondary battery.

The electrode structure 100 may include a current collector 110 and an active material layer 120. The current collector 110 may be made of various kinds of metal materials. As an example, the current collector 110 may be a metal foil including at least any one of copper and aluminum.

The active material layer 120 may be formed in the current collector 110. The active material layer 120 may be a film formed by producing predetermined active material compositions and then, coating it on the surface of the metal foil. The active material layer 120 may include an active material 122 and a conductive material 123.

The active material 122 may be distributed in the entire active material layer 120. Herein, the content of the active material 122 may be controlled to be relatively reduced as compared to that of the conductive material 123 as being away from the current collector 110. To this end, the distribution of the active material 122 may be controlled so that powders having a small size are positioned as being away from the current collector 110. In this case, the occupying area of active material 122 may be relatively reduced as compared to that of the conductive material 123 as being away from the current collector 110. In this case, it may be preferable that the occupying area of the active material 122 is controlled to be gradually reduced as being away from the current collector 110.

The active material 122 may be selected from various kinds of carbon materials. For example, the carbon material may include at least any one of activated carbon, graphite, carbon aerogel, polyacrylonitrile (PAN), carbon nano fiber (CNF), activating carbon nano fiber (ACNF), and vapor grown carbon fiber (VGCF).

The conductive material 123 may be material imparting conductivity to the active material layer 120. For example, the conductive material 123 may include different kinds of first conductive material 124 and second conductive material 126.

The first conductive material 124 may be a conductive material having a small particle size as compared to the active material 110. The first conductive material 124 may be substantially provided in a powder form and may be provided to surround the peripheral of the carbon particle of the active material 122. The first conductive material 124 may be substantially uniformly distributed over the active material layer 120.

The second conductive material 126 may be a conductive material having higher electric conductivity than the first conductive material 124. In addition, the second conductive material 126 may be controlled to have higher content as being away from the current collector 110. In other words, the second conductive material 126 may be formed to have the relatively more content on the surface of the active material layer 120 that is exposed to the outside.

As the conductive material 123, various kinds of conductive materials may be used. For example, as the first conductive material 124, at least any one of carbon black, ketjen black, carbon nano tube, and graphene may be used, and as the second conductive material 126, the other one of the carbon black, the ketjen black, the carbon nano tube, and the graphene may be used. Herein, when considering the use purpose and characteristics of the first and second conductive materials 124 and 125, it may be preferable that the first conductive material 124 substantially has a spherical shape and the second conductive material 126 substantially has a bar shape. Considering this, as the first conductive material 124, the carbon black having a smaller particle size as compared to the particle size of the active material may be used, and as the second conductive material 126, any one of the carbon nano tube (CNT) and the graphene may be used. Although the exemplary embodiment describes, by way of example, the case where the first conductive material 124 substantially having the spherical shape and the second conductive material 126 substantially having the bar shape, the particle shape, size, and kind, or the like, of the first and second conductive materials 124 and 126 may not be limited thereto.

As described above, the electrode structure 100 according to the exemplary embodiment of the present invention may include the active material layer 120 having the content of the conductive material 123 relatively higher than that of active material 122, as being away from the current collector 110. In this case, the electrode structure may take a structure that the resistance of the active material layer 120 may be reduced as being away from the current collector 110, such that the entire resistance of the active material layer 120 may be substantially the same or may be reduced as being away from the current collector 110. Therefore, the electrode structure according to the present invention relatively increases the content of the active material 122 in the area adjacent to the current collector 110 to increase the capacitance of the electrode and relatively increases the content of the conductive material 123 in the area away from the current collector 110 to increase the application of the electrode.

In addition, the electrode structure 100 according to the exemplary embodiment of the present invention includes the conductive material 123 having the relatively higher content as compared to the active material 122 as being away from the current collector 110 but the conductive material 123 may include the second conductive material 126 having high electric conductivity such as the carbon nano tube (CNT) having a fibrous bundle shape or graphene having a sheet shape, together with the first conductive material 124 such as the carbon black. In this case, the resistance of the active material layer 120 is reduced in the area relatively away from the current collector 110, thereby making it possible to increase the application in the entire area of the active material layer 120. Therefore, when the electrode structure is used as the electrode of the energy storage apparatus, the capacitance, the electrode filling rate, and the electrode application of the energy storage apparatus can be improved.

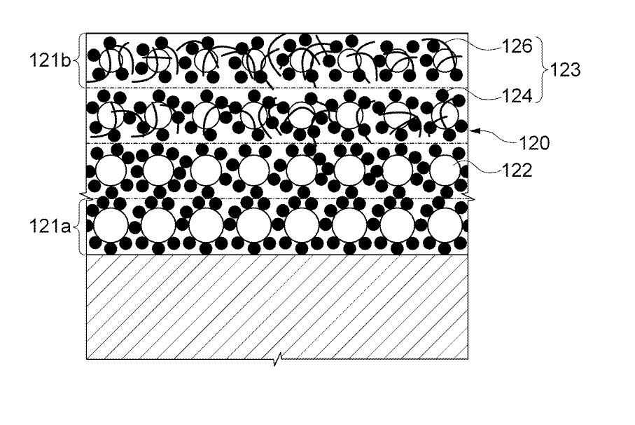

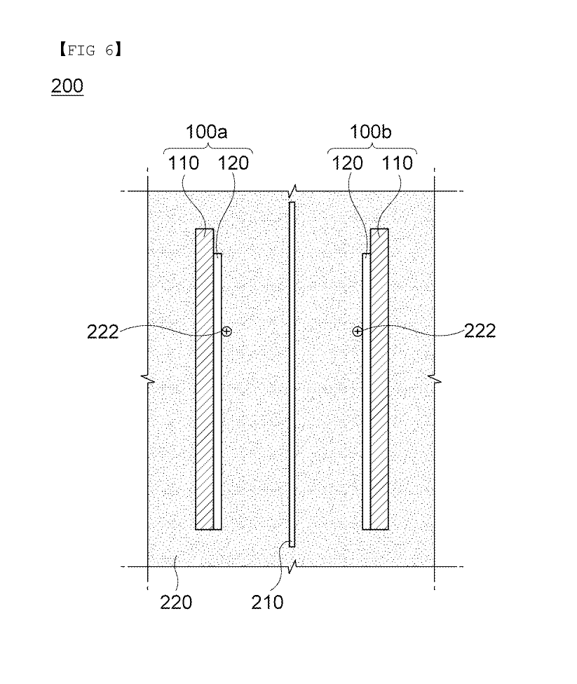

To be continued, the method for manufacturing the above-mentioned electrode structure will be described in detail. FIG. 3 is a flowchart showing a method for manufacturing an electrode structure according to an exemplary embodiment of the present invention. FIGS. 4 and 5 are diagrams for explaining a method of manufacturing an electrode structure according to the exemplary embodiment of the present invention.

Referring to FIGS. 3 and 4, the current collector 110 may be prepared (S110). The preparing the current collector 110 may be formed by preparing a plate made of a metal. As an example, the preparing the current collector 110 may include preparing an aluminum foil. As another example, the method may include preparing the copper foil.

A first active material composition 121a may be formed in the current collector 110 (S120). First, the first active material composition 121a may be prepared. The preparing the first active material composition 121a may include producing a first paste by mixing the active material 122, the first conductive material 124, and material for improving the viscosity and application characteristic of other compositions, or the like. In this case, as the active material 122, the activated carbon may be used and as the first conductive material 124, the carbon black may be used.

The first paste may be coated on the surface of the current collector 110. Therefore, the first active material composition 121a including the active material 122 and the first conductive material 124 may be formed on the current collector 110.

Referring to FIGS. 3 and 5, the second active material composition 121b having the content of the conductive material 123 relatively higher than that of the first active material composition 121a may be formed by being stacked on the first active material composition 121a (S130). First, the second active material composition 121b may be produced. The producing the second active material composition 121b may include producing a second paste having the content of the conductive material 123 relatively higher than that of the first active material composition 121a. As an example, the producing the second paste may be made by mixing the active material 122 having a smaller particle size than that of the active material 122 of the first paste, the first conductive material 124 having substantially the same particle size as the first conductive material 124 of the first paste, and materials for improving the viscosity and application characteristic of other compositions, etc.

In addition, the producing the second paste may be configured to further include the second conductive material 126. The second conductive material 126 may be a conductive powder having higher electric conductivity than the first conductive material 124. As the second conductive material 126, at least any one of the carbon nano tube having a fibrous bundle shape or graphene having a sheet shape may be used. Therefore, the second paste may have the higher electric conductivity than that of the first paste, due to the higher content of the second conductive material 126.

Further, the second paste may be coated on the current collector 110 to which the first paste is applied. In this case, the coating the second paste may be repeatedly performed several times. At this time, the pastes applied at the time of a subsequent coating process may be controlled to gradually increase the content of the conductive material 123. In other words, the method for manufacturing an electrode structure according to the present invention may prepare the pastes having the relatively different contents of conductive material 123 as compared to the active material 122 and then, sequentially coat the pastes having the high content of conductive material 123 from the pastes having the low content of conductive material 123 on the current collector 110. Therefore, the electrode structure 100 formed with the active material layer 120 with the increased content of the conductive material 123 as being away from the current collector 110 may be manufactured on the current collector 110.

As described above, the method for manufacturing an electrode structure according to the present invention may prepare the active material compositions having the relatively different contents of conductive material 123 as compared to the active material 122 and then, sequentially coat the active material composition having the high content of conductive material 123 from the active material composition having the low content of conductive material 123 on the current collector 110. In this case, the electrode structure 110 has a structure that the content of the active material 122 is relatively higher as approaching the current collector 110 and the content of the conductive material 123 is relatively higher as being away from the current collector 110. Therefore, the method for manufacturing an electrode structure according to the present invention can manufacture the electrode structure having the structure in which the content of the active material 122 is relatively increased in the area adjacent to the current collector 110 to increase the capacitance and the content of the conductive material 123 is relatively increased in the area away from the current collector 110 to increase the application of the electrode.

In addition, the method for manufacturing an electrode structure according to the exemplary embodiment of the present invention repeatedly stacks the active material composition having the relatively higher content of conductive material 123 as compared to the active material 122 on the current collector 110, thereby making it possible to manufacture the electrode structure 100 having the active material layer 120 in which the entire resistance is the same or the active material layer 120 having a low resistance as being away from the current collector 110 Therefore, the method for manufacturing an electrode structure according to the present invention uses the entire active material layer 120 independently of the thickness and distance of the current collector 110, thereby making it possible to manufacture the electrode structure with the increased capacitance and application.

Hereinafter, the energy storage apparatuses according to the exemplary embodiments of the present invention will be described in detail. Herein, the overlapped description of the electrode structure 100 described with reference to FIGS. 1 and 2 may be omitted or simplified.

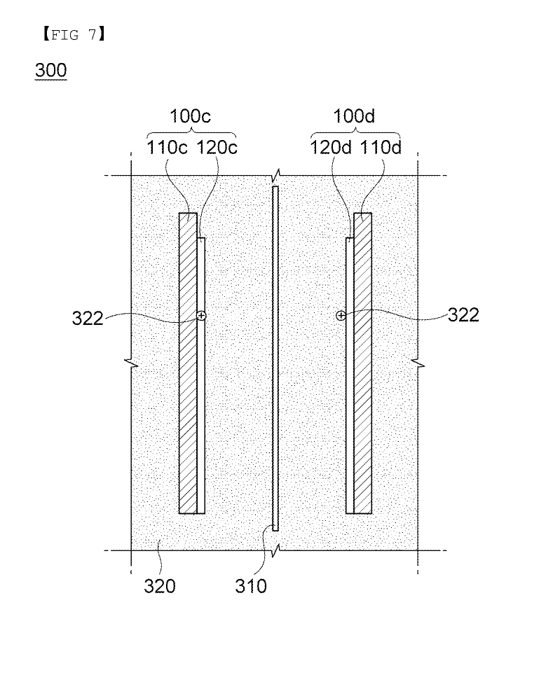

FIG. 6 is a diagram showing an energy storage apparatus according to an exemplary embodiment of the present invention. Referring to FIGS. 1, 2 and 6, an energy storage apparatus 200 according to an exemplary embodiment of the present invention may include electrode structures 100a and 100b, a separator 210, and an electrolyte solution 220.

The electrode structures 100a and 100b may each be substantially the same as the electrode structure 100 described with reference to FIGS. 1 and 2. The electrode structures 100a and 100b may be disposed to face each other, having the separator 210 therebetween. Among the electrode structures 100a and 100b, the electrode structure disposed at one side of the separator 210 may be used as a negative electrode 100a of the energy storage apparatus 200 and among the electrode structures 100a and 100b, the electrode structure disposed at the other side of the separator 210 may be used as a positive electrode 100b of the energy storage apparatus 200.

The negative electrode 100a and the positive electrode 100b may each include the current collector 110 and the active material layer 120 coated on the current collector 110. Herein, the current collector 110 may include an aluminum (Al) foil and the active material layer 120 may include activated carbon as an active material. As described with reference to FIGS. 1 and 2, the active material layer 120 may have as structure in which the content of the active material 122 is reduced the content of the conductive material 123 is increased as being away from the current collector 110. In addition, the first conductive material 123 may include the first conductive material 124 and the second conductive material 126 having electric conductivity higher than that of the first conductive material 124 and the second conductive material 126 may have the high content as being away from the current collector 110.

The separator 210 may be disposed between the electrode structures 100a and 100b. The separator 210 may electrically isolate the negative electrode 100a from the positive electrode 100b. As the separator 210, at least any one of nonwoven fabric, polytetrafluorethylene (PTFE), a porous film, a craft fiber, a cellulosic electrolytic paper, rayon fiber, and other various kinds of sheets may be used.

The electrolyte solution 220 may be a composition produced by melting a second electrolyte salt in a predetermined solvent. The second electrolyte salt may include cations 222 that absorb and desorb onto and from the surface of the active material layer 124 by a charging and discharging mechanism. As the second electrolyte salt, non-lithium-based electrolyte salt may be used. The non-lithium-based electrolyte salt may be salt including non-lithium ions used as carrier ions between the negative electrode 100a and the positive electrode 100b at the time of charging and discharging operations of the energy storage apparatus 200. For example, the non-lithium-based electrolyte salt may include ammonium ions (NH4⁺). More specifically, the non-lithium-based electrolyte salt may include at least any one of tetraethyl ammonium tetrafluoroborate (TEABF4), tetraethylmethyl ammonium tetrafluoroborate (TEMABF4), ethylmethyl ammonium tetrafluoro (EMBF4), and diethylmethyl ammonium tetrafluoroborate (DEMEBF4). Alternatively, the non-lithium-based electrolyte salt may include spirobipyrrolidinium tetrafluoroborate (SBPBF4).

In addition, the solvent may include at least any one of a cyclic carbonate and a linear carbonate. For example, as the cyclic carbonate, at least any one of ethylene carbonate (EC), propylene carbonate (PC), butylene carbonate (BC), and vinyl ethylene carbonate (VEC) may be used. As the linear carbonate, at least any one of dimethyl carbonate (DMC), methyl ethyl carbonate (MEC), diethyl carbonate (DEC), methyl propyl carbonate (MPC), dipropyl carbonate (DPC), metylbutyl carbonate (MBC), and dibutyl carbonate (DBC) may be used. Various kinds of ether, ester, and amide-based solvent may also be used.

The energy storage apparatus 200 having the above-mentioned structure includes the current collector 110 and the negative electrode 110a and the positive electrode 110b having the active material layer 120 formed in the current collector 110 so that the resistance is lowered as being away from the current collector 110. As the current collector 110, the aluminum foil may be used and the active material layer 120 may include the activated carbon 122. Therefore, the energy storage apparatus 100 having the above-mentioned structure may be used as the electric double layer capacitor (EDLC) driven by performing the electric double layer charging using the activated carbon by the charging and discharging reaction mechanism.

In this case, the energy storage apparatus 200 can include the negative electrode 100a and the positive electrode 100b that relatively increase the content of the active material 122 in the area adjacent to the current collector 110 to increase the capacitance and relatively increase the content of the conductive material 123 in the area away from the current collector 110 to increase the application of the electrode. Therefore, the energy storage apparatus according to the present invention includes the electrode structure that increases the capacitance and the application of ht electrode, thereby making it possible to implement the equivalent series resistance (ESR), the high capacity, and the high output.

FIG. 7 is a diagram showing an energy storage apparatus according to another exemplary embodiment of the present invention. Referring to FIGS. 1, 2, and 7, an energy storage apparatus 300 according to another exemplary embodiment of the present invention may include electrode structures 100c and 100d, a separator 310, and an electrolyte solution 320

The electrode structures 100c and 100d may each be substantially the same as the electrode structure 100 described with reference to FIGS. 1 and 2. The electrode structures 100c and 100d may be disposed to face each other, having the separator 310 therebetween Among the electrode structures 100c and 100d, the electrode structure disposed at one side of the separator 310 may be used as a negative electrode 100c of the energy storage apparatus 300 and among the electrode structures 100c and 100d, the electrode structure disposed at the other side of the separator 310 may be used as a positive electrode 100d of the energy storage apparatus 300

The negative electrode 100c and the positive electrode 100d may each include different kinds of current collectors and the active material layer coated on the current collector. As an example, the negative electrode 100c may be configured to include the current collector 110c including the copper foil and the active material layer 120c including the graphite. On the other hand, the positive electrode 100d may be configured to include the current collector 110d including the aluminum foil and the active material layer 120d including the activated carbon. In this case, the active material layer 120c of the negative electrode 100c may have a structure in which the content of the active material is reduced but the content of the conductive material is relatively increased as being away from the current collector 110c. In a similar manner, the active material layer 120d of the positive electrode 100d may have a structure in which the content of the active material is reduced as being away from the current collector 110d but the content of the conductive material is relatively increased.

The separator 310 may be disposed between the electrode structures 100c and 100d. The separator 310 may electrically isolate the negative electrode 100c from the positive electrode 100d. As the separator 310, at least any one of nonwoven fabric, polytetrafluorethylene (PTFE), a porous film, a craft fiber, a cellulosic electrolytic paper, rayon fiber, and other various kinds of sheets may be used.

The electrolyte solution 320 may be a composition prepared by melting a predetermined electrolyte salt in the solvent. The electrolyte salt may include cations 322 that absorb and desorb onto and from the surface of the active material layer 124 by a charging and discharging mechanism. In addition, the cations 322 may be operated to have the charging reaction mechanism absorbed on the surface of the active material layer 124 of the positive electrode 100d. As the electrolyte salt, lithium-based electrolyte salt may be used. The lithium-based electrolyte salt may be salt including lithium ions (Li⁺) as carrier ions between the negative electrode 110c and the positive electrode 100d at the time of charging and discharging operations of the energy storage apparatus 300. For example, the lithium-based electrolyte salt may include at least any one of LiPF6, LiBF4, LiSbF6, LiAsF5, LiClO4, LiN, CF3SO3, and LiC. Alternatively, the lithium-based electrolyte salt may include at least any one of LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

In addition, the solvent may include at least any one of a cyclic carbonate and a linear carbonate. For example, as the cyclic carbonate, at least any one of ethylene carbonate (EC), propylene carbonate (PC), butylene carbonate (BC), and vinyl ethylene carbonate (VEC) may be used. As the linear carbonate, at least any one of dimethyl carbonate (DMC), methyl ethyl carbonate (MEC), diethyl carbonate (DEC), methyl propyl carbonate (MPC), dipropyl carbonate (DPC), metylbutyl carbonate (MBC), and dibutyl carbonate (DBC) may be used. Various kinds of ether, ester, and amide-based solvent may also be used.

The energy storage apparatus 300 having the above-mentioned structure may include the negative electrode 100c configured to include the current collector 110c including the copper foil and the active material layer 120c including graphite, the positive electrode 100d configured to include the current collector 110d including the aluminum foil and the active material layer 120d including the activated carbon, and the electrolyte solution 320 having the lithium-based electrolyte salt. Therefore, the energy storage apparatus 300 may be used as the lithium ion capacitor (LIC) using the lithium ions (Li⁺) as the carrier ions of the electrochemical reaction mechanism.

In this case, the energy storage apparatus 300 can include the structure that relatively increases the content of the active material in the area adjacent to the current collectors 110c and 110d to increase the capacitance and relatively increases the content of the conductive material in the area away from the current collectors 110c and 110d to increase the application of the electrode Therefore, the energy storage apparatus according to the present invention includes the electrode structure that increases the capacitance and the application of the electrode, thereby making it possible to implement the equivalent series resistance (ESR), the high capacity, and the high output.

The electrode structure according to the present invention includes the active material layer having the structure in which the content of the conductive material is relatively further increased than the active material as being away from the current collector, thereby making it possible to have the structure in which the resistance of the active material layer is reduced as being away from the current collector. Therefore, the electrode structure according to the present invention can relatively increase the content of the active material in the area adjacent to the current collector to increase the capacitance of the electrode and relatively increase the content of the conductive material in the area away from the current collector to increase the application of the electrode.

The method for manufacturing an electrode structure according to the present invention can manufacture the electrode structure by preparing the active material compositions having the relatively different contents of the conductive materials as compared to the active material and then, sequentially stacking the high active material compositions from the active material compositions having the low content of the conductive material on the current collector. Therefore, the method for manufacturing an electrode structure according to the present invention can manufacture the electrode structure having the structure in which the content of the active material is relatively increased in the area adjacent to the current collector to increase the capacitance and the content of the conductive material is relatively increased in the area away from the current collector to increase the application of the electrode.

The energy storage apparatus according to the present invention may include the negative electrode and the positive electrode having the structure in which the content of the active material is relatively increased in the area adjacent to the current collector to increase the capacitance of the electrode and the content of the conductive material is relatively increased in the area away from the current collector to increase the application of the electrode Therefore, the energy storage apparatus according to the present invention includes the electrode structure that increases the capacitance and increases the application of the electrode, thereby making it possible to implement the equivalent series resistance (ESR), the high capacity, and the high output.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electrode structure, comprising:
a current collector; and
an active material layer formed in the current collector,
wherein the active material layer includes:
an active material; and
a conductive material having a relatively higher content than that of the active material as being away from the current collector.

2. The electrode structure according to claim 1, wherein the active material has a smaller occupying area as being away from the current collector.

3. The electrode structure according to claim 1, wherein the active material includes a carbon material having a smaller size as being away from the current collector.

4. The electrode structure according to claim 3, wherein the carbon material includes at least any one of activated carbon, graphite, carbon aerogel, polyacrylonitrile (PAN), carbon nano fiber (CNF), activating carbon nano fiber (ACNF), and vapor grown carbon fiber (VGCF).

5. The electrode structure according to claim 1, wherein the conductive material includes a conductive powder having a higher occupying area as being away from the current collector.

6. The electrode structure according to claim 5, wherein the conductive powder includes at least any one of carbon black, ketjen black, carbon nano tube, and graphene.

7. The electrode structure according to claim 1, wherein the conductive material further includes:
a first conductive material uniformly distributed on the active material layer; and
a second conductive material having a high content as being away from the current collector and having electric conductivity higher than that of the first conductive material.

8. The electrode structure according to claim 7, wherein the first conductive material includes at least any one of carbon black, ketjen black, carbon nano tube, and graphene, and
the second conductive material includes the other one of the carbon black, the ketjen black, the carbon nano tube, and the graphene.

9. A method for manufacturing an electrode structure, comprising:
preparing a current collector;
preparing a plurality of active material compositions having relatively different contents of conductive material as compared to the active material; and
sequentially forming the active material composition having the high content of the conducive material from the active material composition having the relatively low content of the conductive material among the active material compositions on the current collector.

10. The method for manufacturing an electrode structure according to claim 9, wherein the preparing the active material compositions includes:
preparing a first active material composition including the active material and the conductive material; and
preparing a second active material composition having the relatively higher content of the conductive material than that of the first active material composition, and
the sequentially forming the active material composition having the high content of the conducive material from the active material composition having the relatively low content of the conductive material includes:
applying the first active material composition on the current collector; and
applying the second active material composition on the first active material composition.

11. The method for manufacturing an electrode structure according to claim 9, wherein the preparing the active material compositions includes:
preparing a first active material composition including the active material and the conductive material; and
preparing a second active material composition having the size of the active material smaller than that of the first active material composition.

12. The method for manufacturing an electrode structure according to claim 9, wherein the active material includes at least any one of activated carbon, graphite, carbon aerogel, polyacrylonitrile (PAN), carbon nano fiber (CNF), activating carbon nano fiber (ACNF), and vapor grown carbon fiber (VGCF).

13. The method for manufacturing an electrode structure according to claim 9, wherein the conductive material includes a conductive powder having electric conductivity higher than the active material, and
the conductive powder includes at least any one of carbon black, ketjen black, carbon nano tube, and graphene.

14. The method for manufacturing an electrode structure according to claim 9, wherein the conductive material includes a first conductive material and a second conductive material having electric conductivity higher than that of the first conductive material,
the first conductive material uses at least any one of carbon black and ketjen black, and
the second conductive material uses at least any one of carbon nano tube and graphene.

15. An energy storage apparatus, comprising:
an electrolyte solution;
a separator disposed in the electrolyte solution;
a negative electrode disposed at one side of the separator in the electrolyte solution; and
a positive electrode disposed at the other side of the separator in the electrolyte solution,
wherein the negative electrode and the positive electrode each includes:
a current collector; and
an active material layer formed in the current collector,
wherein the active material layer includes:
an active material; and
a conductive material having a relatively higher content than that of the active material as being away from the current collector.

16. The energy storage apparatus according to claim 15, wherein the active material includes a carbon material having a smaller size as being away from the current collector, and
the carbon material includes at least any one of activated carbon, graphite, carbon aerogel, polyacrylonitrile (PAN), carbon nano fiber (CNF), activating carbon nano fiber (ACNF), and vapor grown carbon fiber (VGCF).

17. The energy storage apparatus according to claim 15, wherein the conductive material includes a carbon material having a high content as being away from the current collector, and
the conductive powder includes at least any one of carbon black, ketjen black, carbon nano tube, and graphene.

18. The energy storage apparatus according to claim 15, wherein the current collector of the negative electrode and the positive electrode includes an aluminum foil,
the active material layer includes activated carbon, and
the negative electrode and the positive electrode form an electrode structure of an electric double layer capacitor (EDLC).

19. The energy storage apparatus according to claim 15, wherein the current collector of the negative electrode includes a copper foil,
the active material layer of the negative electrode include graphite,
the current electrode of the positive electrode includes an aluminum foil,
the active material layer of the positive electrode includes activated carbon, and
the negative electrode and the positive electrode form an electrode structure of a lithium ion capacitor (LIC).

20. The energy storage apparatus according to claim 15, wherein the electrolyte solution includes at least any one of tetraethyl ammonium tetrafluoroborate (TEABF4), tetraethylmethyl ammonium tetrafluoroborate (TEMABF4), ethylmethyl ammonium tetrafluoro (EMBF4), and diethylmethyl ammonium tetrafluoroborate (DEMEBF4) or the non-lithium-based electrolyte salt includes spirobipyrrolidinium tetrafluoroborate (SBPBF4).

21. The energy storage apparatus according to claim 15, wherein the electrolyte solution includes an electrolyte salt including at least any one of LiPF6, LiBF4, LiSbF6, LiAsF5, LiClO4, LiN, CF3SO3, LiC, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.
